(19) United States
(12) Patent Application Publication
(10) Pub. No.: US 2006/0016881 A1
(43) Pub. Date: Jan. 26, 2006

(54) Contactless smart card system with password

(76) Inventor: Pascal Roux, Chabeuil (FR)

Correspondence Address: PLEVY & HOWARD, P.C., P.O. BOX 226, FORT WASHINGTON, PA, 19034, US

(21) Appl. No.: 11/187,598

(22) Filed: Jul. 22, 2005

(30) Foreign Application Priority Data
Jul. 26, 2004 (FR) 04/51655

(51) Int. Cl. G06K 5/00

(52) U.S. Cl. 235/380

(57) ABSTRACT

A system using a smart card without a processor, capable of being coupled without contact to a reader, this card comprising a first read-protected memory area and containing a password and a second memory area containing data of access to a service accessible in write mode, and possibly in read mode, only if the card receives a code identical to the stored password. After an operation on the card such as an access to a service or to a reloading, the password is modified according to data stored in the card, the current value and the previous value of which are known.

### FIELD OF THE INVENTION

The present invention generally relates to systems using smart cards and more specifically smart cards with a password and comprising storage areas only and no calculation means. Calculations on data contained in such cards are performed only when they are coupled to a reader or read terminal.

### BACKGROUND OF THE INVENTION

As illustrated in FIG. 1A, a card with a password comprises a number of storage areas, among which a card serial number storage area SN, a service data storage area DATA, and a password storage area PW. The service data correspond to rights of access to a service or of acquisition of a good and can be modified on each presentation of the card before a read terminal.

As will be indicated hereafter, the present invention more specifically relates to contactless cards, which generally comprise a coil which couples with a corresponding coil of a read terminal, which is both used to supply the card and to perform transactions therewith.

The typical scheme of a transaction is illustrated in FIG. 1B.

When the card is brought close to a read terminal, the reader first reads serial number SN of the card, then, with a calculation block 1, calculates password PW from a secret algorithm, and sends password PW to the card. At this time only can the data be read from the card, area DATA being blocked by construction as long as the password has not been provided. The data are processed by a processing circuit 2 of the reader which sends updated data back to the card. Then, with a terminal 3, circuit 2 controls an access to the required service, for example, the opening of a gate or the unlocking of a drawer.

According to cases, the new data correspond to the writing of a monetary amount value or of a number of accesses to the card. Or, if the card is an access authorization card for a determined period, the passage date is simply written. The new data may also correspond, on request of the card bearer, to a reloading of the card to increase its number of accesses to a service or its duration of validity.

If a contactless card is moved away from the read terminal before the end of the transaction, for example, before writing of new data, the access to the service is refused and the card bearer must present said card again longer before the reader. All the previously-discussed operations are then repeated.

A disadvantage of this type of card is that, given that the password is fixed, the card bearer or another person having stolen the card can try to decipher the code by various means despite the precautions taken to avoid this finding. He can then reload new data into the card.

To avoid this type of fraud, a certificate area containing a control value which is modified according to the data variations in the card, as for example described in French patent 2700864, is often added to this type of card. However, such a certificate does not prevent a person attempting to fraud from modifying the amount in the card. However, if the card user puts in a claim, it is very difficult to prove that there effectively has been a fraud or that there has been an error in the card operation.

### SUMMARY OF THE INVENTION

Thus, the present invention aims at finding a more secure system and method and leaving no ambiguity in case of a fraud.

To achieve this object, the present invention provides a password modification system.

More specifically, the present invention provides a system using a smart card, without a processor, capable of being coupled without contact to a reader, this card comprising a first read-protected memory area and containing a password and a second memory area containing data of access to a service accessible in write mode, and possibly in read mode, only if the card receives a code identical to the stored password; in which, after an operation on the card such as an access to a service or to a reloading, the password is modified according to data stored in the card, the current value and the previous value of which are known.

According to an embodiment of the present invention, the stored data correspond to the content of a counter, the value of which can only vary in a given direction, this value being modified on said operation.

According to an embodiment of the present invention, the stored value uses the data of access to the service, the card storing on each operation the current data and the previous data.

According to an embodiment of the present invention, the reader calculates a password on the one hand based on the current data, on the other hand based on the previous data.

The foregoing and other objects, features, and advantages of the present invention will be discussed in detail in the following non-limiting description of specific embodiments in connection with the accompanying drawings.

### BRIEF DESCRIPTION OF THE DRAWINGS

FIGS. 1A and 1B respectively show memory areas of a conventional smart card with a password and a conventional read mode of such a smart card,

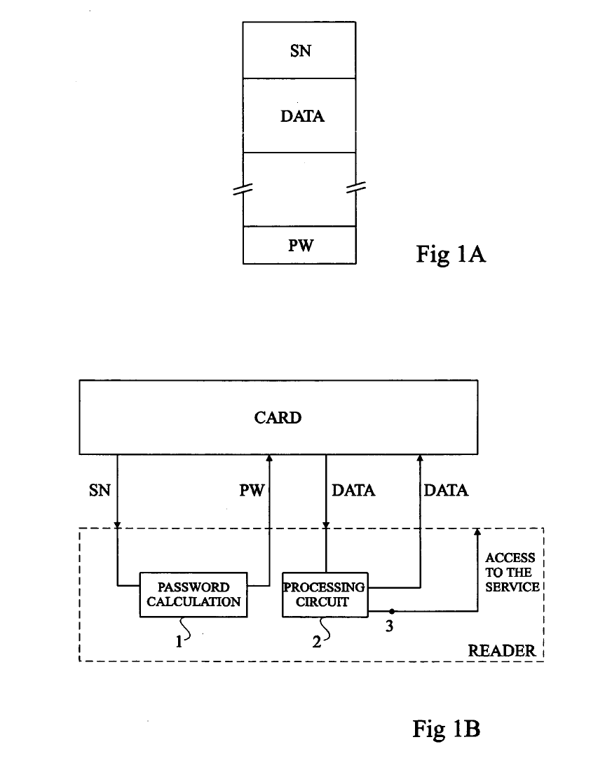

FIGS. 2A and 2B respectively show memory areas of a smart card with a password according to a first embodiment of the present invention and a read mode of such a smart card; and

FIGS. 3A and 3B respectively show memory areas of a smart card with a password according to a second embodiment of the present invention and a read mode of such a smart card

### DETAILED DESCRIPTION

Generally, the present invention provides periodically updating the password, for example, on each operation performed on the card. However, as will be seen hereafter, this poses a difficulty in the case where a transaction is inadvertently interrupted in the presentation of the card to the reader, which leads to a solution distinct from that adopted in the case of a certificate updating smart card.

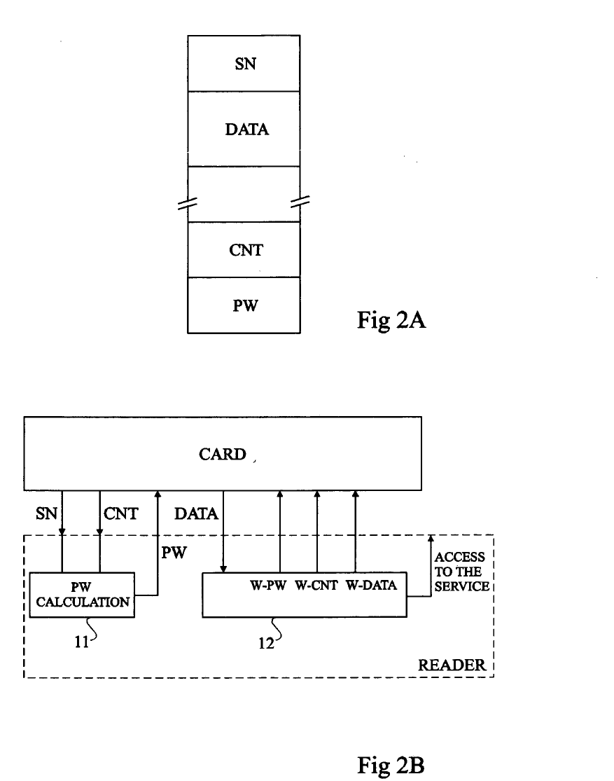

FIGS. 2A and 2B illustrate a first embodiment of the present invention.

In this embodiment, the smart card contains various storage areas, among which a serial number area SN, an area of access to a service DATA, a password area PW, and a counter area CNT. The serial number and counter areas are free to be read. Data area DATA is blocked in write mode as long as password PW has not been provided to the card and is preferably also blocked in read mode as long as this password has not been provided. Password area PW is always blocked in read mode and is blocked in write mode as long as a password identical to the password which is stored in this area at a given time has not been sent to the card.

As illustrated in FIG. 2B, when a card is presented to a read terminal, the terminal first reads from a password calculation block 11 serial number SN of the card, and the content of counter CNT. Block 11 applies a secret algorithm to these two sets of data, possibly taking into account other data stored in the card and/or in the read system. It then provides a password PW that must correspond to the password stored in the card. This unlocks the reading from the data storage area and the data are read in a block 12 of the reader. The reader then successively provides the card with
an instruction W-PW for writing a new password corresponding to a calculation performed based on the content of the counter incremented by one unit (or by a determined number of units);
an instruction W-CNT for writing into the counter area the new counter value; then
an instruction W-DATA for writing into the data area new data, the new data varying with respect to the former in accordance with what is provided in the card management and service access system.

After this, the access to the service is provided, for example, the opening of a gate.

However, in current read terminal systems, the intervals between write operations take a non-negligible time, for example, on the order of 10 ms. In the case of contactless cards, the communication between the card and the terminal may be interrupted between two successive operations. A problem is in particular posed if the coupling is interrupted between the writing of the new password and the writing of the new counter value. Of course, there then is no access to the service (nor card debit) but, further, there then exists in the card a discordance between the new password and the content of the counter. This poses a problem especially due to the fact that the card is capable of being presented to one or the other of many different read terminals.

Thus, the present invention provides that the counter can only be modified in a given direction (increment or decrement) and only by a predetermined quantity. Correlatively, it is provided in the read terminal management system that the password calculation can be performed twice on each presentation of a card, on the one hand based on the present value of the counter, and on the other hand based on the value that it should have taken if a transaction had not aborted. Thus, the user is always allowed access to the service. In the case where there is a discordance between the values of the content of the counter and of the password, on the next passing, the counter is not incremented again to recover the synchronization.

According to an alternative of this first embodiment of the present invention, an updating of the card counter may be provided before updating of the password. A second password calculation operation with a value shifted by one unit of the counter content will also have to be performed in case of a failure, but in a direction opposite to what has been explained previously.

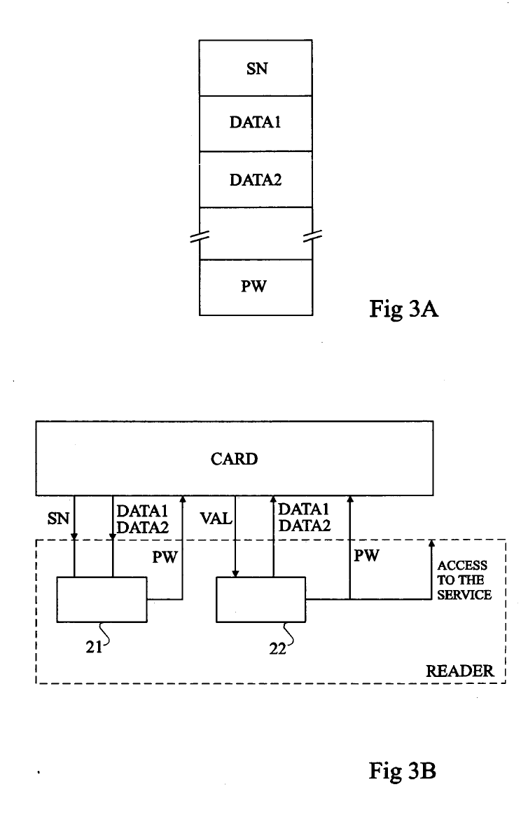

FIGS. 3A and 3B illustrate a second embodiment of the present invention.

As illustrated in FIG. 3A, in this second embodiment, each card comprises a serial number storage area SN, two data storage areas DATA1 and DATA2, and a password storage area PW. In areas DATA1 and DATA2, the data present in the card before a transaction and after a transaction are respectively stored In other words, after each operation performed in relation with the card, the more recent of the two sets of data present in the card is kept and the new data resulting from the operation are rewritten.

The protections of the various areas are such as indicated previously except that areas DATA1 and DATA2 are free in read mode and protected only in write mode by the password.

The sequence of operations with a read terminal is such as illustrated in FIG. 3B.

When the card is presented to a read terminal, said terminal (block 21) reads serial number SN and the most recent of data sets DATA1 and DATA2. Block 21 calculates, normally with these last data, the password and sends it to the card. If the password is the right one, the card returns a validation signal VAL and the reader writes back into the memory area containing the oldest data the new data resulting from the transaction. Then, block 21 writes a new password PW into the card, the new password being calculated based on the last written data and on the content of memory area SN and possibly other memory areas of the card. After this, an access to the service is granted.

As in the first embodiment, a problem may arise if the coupling between the card and the read terminal is interrupted during the transaction, here between the writing of the new data and the writing of the new password. Thus, in case of a failure, the present invention provides for block 21 to perform again an algorithmic calculation of the password based on the other one of data sets DATA1 and DATA2. It is then certain to find the right password. In this case, no writing of the last data set is performed since this has aleady been done.

Of course, the present invention may have various alterations, modifications, and improvements which will readily occur to those skilled in the art. In particular, at the level of the read terminals, elements presented for simplification as hardware elements will often in practice be programmed elements. Further, although a modification of the password on each operation performed on the card has been described, it should be noted that this modification may be performed periodically only, as decided by the manager of the read terminal network, for example, once a day, once a month, each time the card has been presented more than a given number of times, etc.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A system using a smart card without a processor, said card capable of being coupled without contact to a reader, said card comprising:
a first read-protected memory area containing a password; and
a second memory area containing data of access to a service accessible in write mode, only if the card receives a code identical to the stored password,
wherein, after an operation on the card such as an access to a service or a reloading, said password is modified according to data stored in the card, the current value and the previous value of which are known.

2. The system of claim 1, wherein said stored data correspond to the content of a counter, the value of which can only vary in a given direction, this value being modified on said operation.

3. The system of claim 1, wherein said stored value uses the data of access to the service, the card storing on each operation the current data and the previous data.

4. The system of claim 3, wherein the reader calculates a password based on the current data.

5. The system of claim 3, wherein the reader calculates a password based on the previous data.

6. The system of claim 1, wherein said second memory area contains data of access to a service further accessible in read mode, only if the card receives a code identical to the stored password.
